(19) United States
(12) Patent Application Publication
(10) Pub. No.: US 2007/0101905 A1
(43) Pub. Date: May 10, 2007

(54) Fluid loss control additives for foamed cement compositions and associated methods

(75) Inventors: Jiten Chatterji, Duncan, OK (US); D. Chad Brenneis, Marlow, OK (US); Bobby J. King, Duncan, OK (US); Karl Heinz Heier, Frankfurt am Main (DE); Juergen Tonhauser, Winkel (DE)

Correspondence Address: CRAIG W. RODDY;HALLIBURTON ENERGY SERVICES, P.O. BOX 1431, DUNCAN, OK, 73536-0440, US

(73) Assignee: Halliburton Energy Services, Inc.

(21) Appl. No.: 11/267,072

(22) Filed: Nov. 4, 2005

(51) Int. Cl. C04B 16/08; C04B 20/00

(52) U.S. Cl. 106/672; 106/682; 106/678

(57) ABSTRACT

Provided herein are foamed cement composition that comprises a hydraulic cement, water, a gas, a foaming and stabilizing surfactant, and a fluid loss control additive comprising a copolymer.

### BACKGROUND

The present invention relates to cementing operations, and more particularly, to polymeric fluid loss control additives for foamed cement compositions, and methods of using such compositions in surface and subterranean applications.

Hydraulic cement compositions are commonly utilized above ground (e.g., in the construction industry) and in subterranean operations, particularly subterranean well completion and remedial operations. For example, hydraulic cement compositions are used in primary cementing operations whereby pipe strings such as casings and liners are cemented in well bores. In performing primary cementing, hydraulic cement compositions are pumped into the annular space between the walls of a well bore and the exterior surface of the pipe string disposed therein. The cement composition is permitted to set in the annular space, thereby forming an annular sheath of hardened substantially impermeable cement therein that substantially supports and positions the pipe string in the well bore and bonds the exterior surface of the pipe string to the walls of the well bore. Hydraulic cement compositions also are used in remedial cementing operations such as plugging highly permeable zones or fractures in well bores, plugging cracks and holes in pipe strings, and the like.

Cement compositions utilized in subterranean operations may be lightweight to prevent excessive hydrostatic pressure from being exerted on subterranean formations penetrated by the well bore, whereby the formations may be unintentionally fractured. One type of lightweight cement composition is a foamed cement composition, i.e., a cement composition that comprises a gas. In addition to being lightweight, the gas contained in the foamed cement composition may improve the ability of the composition to maintain pressure and prevent the flow of formation fluids into and through the cement composition during its transition time, i.e., the time during which the cement composition changes from a true fluid to a set mass. Foamed cement compositions are advantageous because they have low fluid loss properties and may act to prevent the loss of fluid during circulation. Additionally, foamed cement compositions when set should have a lower modulus of elasticity than non-foamed cements, which is often desirable as it enables the resultant set cement, inter alia, to resist hoop stresses exerted on the set cement in the annulus.

For such well cementing operations to be successful, the cement compositions utilized typically include a fluid loss control additive to reduce the loss of fluid, e.g., water, from the cement compositions when they contact permeable portions of a subterranean formation. Excessive fluid loss, inter alia, may cause a cement composition to be prematurely dehydrated. Premature hydration may result in increased viscosity for the cement composition, which may breakdown the formation and possibly lead to job failure. Fluid loss control agents may also be used in surface cement compositions. Fluid loss control agents may include polymeric fluid loss control additives that may be capable of functioning at a wider range of temperatures.

However, the use of conventional polymeric fluid loss control additives in foamed cement compositions has been problematic. For example, conventional polymeric fluid loss control additives (such as copolymers of acrylamide and 2-acrylamido-2-methylpropane sulfonic acid), in general, have a certain amount of dispersive properties. Because dispersants tend to decrease the viscosity of a cement composition, the inclusion of such polymeric fluid loss control additives may partially or totally destabilize foamed cement compositions, especially at increased temperatures (greater than about 200° F.). The destabilization of the foamed cement composition may exert excessive hydrostatic pressure on the subterranean formation so as to unintentionally fracture the formation. Thus, it is desired to have a polymeric fluid loss control additive having reduced dispersive properties and that will at least partially control fluid loss from foamed cement compositions.

### SUMMARY

The present invention relates to cementing operations, and more particularly, to polymeric fluid loss control additives for foamed cement compositions, and methods of using such compositions in surface and subterranean applications.

An embodiment of the present invention provides a foamed cement composition comprising: a hydraulic cement; water; a gas; a foaming and stabilizing surfactant; and a polymeric fluid loss control additive comprising a copolymer that comprises:
(a) between 5% and about 95% by weight of structural units of Formula I and/or II: 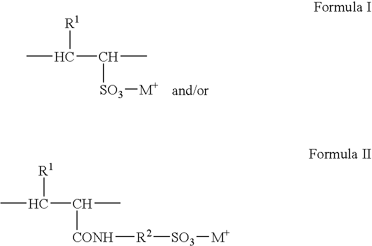
wherein R¹ is H or CH₃, R² is C₂₋ alkylene, and M⁺ is NH₄⁺, Li⁺, Na⁺, or K⁺, and
(b) between about 5% and about 60% by weight of structural units of Formula III: 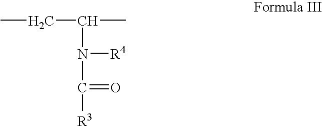
wherein R³ is H, CH₃, or C₂H₅, R⁴ is CH₃ or C₂H₅, or wherein R³ and R⁴ together are a propylene group which with incorporation of the radical 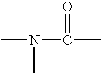
forms a pyrrolidone radical. In some embodiments, the copolymer further comprises between about 0% and about 60% by weight of structural units of Formula IV: 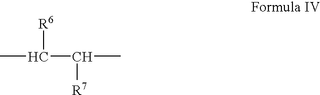
wherein R⁶ is H or CH₃, and R⁷ is carboxamido, carboxyl, cyano, or carboxymethoxy.

Another embodiment of the present invention provides a foamed cement composition comprising: a hydraulic cement; water; a gas; a foaming and stabilizing surfactant; and a polymeric fluid loss control additive comprising a copolymer that comprises:
(a) between 5% and about 95% by weight of structural units that are derived from compounds of Formula V: 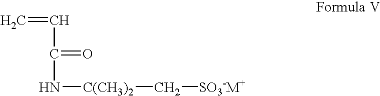
(b) between about 1% and about 95% by weight of structural units that are derived from compounds of Formula VI: 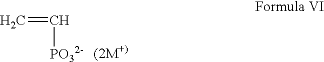
and
(c) between about 1% and about 95% by weight of structural units that are derived from compounds of Formula VII and/or Formula VIII: 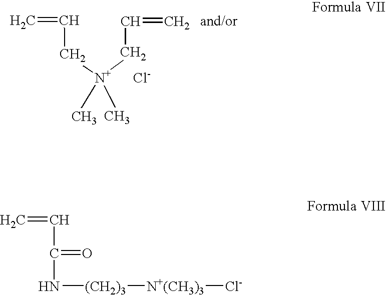
wherein X⁺ is a cation.

The features and advantages of the present invention will be apparent to those skilled in the art. While numerous changes may be made by those skilled in the art, such changes are within the spirit of the invention.

### DESCRIPTION OF PREFERRED EMBODIMENTS

The present invention relates to cementing operations, and more particularly, to polymeric fluid loss control additives for foamed cement compositions, and methods of using such compositions in surface and subterranean applications.

The foamed cement compositions of the present invention generally comprise a hydraulic cement, water, a gas, a foaming and stabilizing surfactant, and a polymeric fluid loss control additive comprising a copolymer. The term “copolymer” as used herein is not limited to the combination of two polymers, but includes any combination of polymers, e.g., terpolymers, tetrapolymers, and the like. Copolymers suitable for use in the present invention are described in more detail below.

A variety of hydraulic cements may be utilized in accordance with the present invention, including, but not limited to, those comprised of calcium, aluminum, silicon, oxygen, and/or sulfur, which set and harden by reaction with water. Suitable hydraulic cements, include, but are not limited to, Portland cements, pozzolana cements, gypsum cements, high alumina content cements, slag cements, and silica cements, and combinations thereof. In certain embodiments, the hydraulic cement may comprise a Portland cement. In some embodiments, the Portland cements that are suited for use in the present invention are classified as Class A, C, H, and G cements according to American Petroleum Institute, API Specification for Materials and Testing for Well Cements, API Specification 10, Fifth Ed., Jul. 1, 1990.

The water used in the foamed cement compositions of the present invention may be freshwater, saltwater (e.g., water containing one or more salts dissolved therein), brine (e.g., saturated saltwater produced from subterranean formations), or seawater, or combinations thereof. Generally, the water may be from any source, provided that it does not contain an excess of compounds that may adversely affect other components in the cement composition. The water may be present in an amount sufficient to form a pumpable slurry. More particularly, the water may be present in an amount in the range of from about 33% and about 200% by weight of the cement (“bwoc”). In some embodiments, the water may be present in an amount in the range of from about 35% and about 70% bwoc.

The gas utilized in the foamed cement compositions of the present invention may be any gas suitable for foaming a cement composition, including, but not limited to, air or nitrogen, or combinations thereof. Generally, the gas should be present in the foamed cement compositions of the present invention in an amount sufficient to form a suitable foam. In certain embodiments, the gas may be present in an amount in the range of from about 10% and about 80% by volume of the composition.

Any suitable foaming and stabilizing surfactant may be used in the foamed cement composition of the present invention. Among other things, the foaming and stabilizing surfactants may facilitate the foaming of a cement composition and/or also stabilize the resultant foamed cement composition formed therewith. Suitable foaming and stabilizing surfactants may include, but are not limited to: a mixture of an ammonium salt of an alkyl ether sulfate, a cocoamidopropyl betaine surfactant, a cocoamidopropyl dimethylamine oxide surfactant, sodium chloride, and water; a mixture of an ammonium salt of an alkyl ether sulfate surfactant, a cocoamidopropyl hydroxysultaine surfactant, a cocoamidopropyl dimethylamine oxide surfactant, sodium chloride, and water; hydrolyzed keratin; a mixture of an ethoxylated alcohol ether sulfate surfactant, an alkyl or alkene amidopropyl betaine surfactant, and an alkyl or alkene dimethylamine oxide surfactant; an aqueous solution of an alpha-olefinic sulfonate surfactant and a betaine surfactant; and combinations thereof. An example of a suitable hydrolyzed keratin is described in U.S. Pat. No. 6,547,871, the relevant disclosure of which is incorporate herein by reference. An example of a suitable mixture of an ethoxylated alcohol ether sulfate surfactant, an alkyl or alkene amidopropyl betaine surfactant, and an alkyl or alkene dimethylamine oxide surfactant is described in U.S. Pat. No. 6,063,738, the relevant disclosure of which is incorporate herein by reference. An example of a suitable aqueous solution of an alpha-olefinic sulfonate surfactant and a betaine surfactant is described in U.S. Pat. No. 5,897,699, the relevant disclosure of which is incorporate herein by reference. In one certain embodiment, the foaming and stabilizing surfactant comprises a mixture of an ammonium salt of an alkyl ether sulfate, a cocoamidopropyl betaine surfactant, a cocoamidopropyl dimethylamine oxide surfactant, sodium chloride, and water.

Generally, the foaming and stabilizing surfactants should be present in the foamed cement compositions of the present invention in an amount sufficient to provide a suitable foam. In some embodiments, the foaming and stabilizing surfactant may be present in an amount in the range of from about 0.8% and about 10% by volume of the water (“bvow”) present in the foamed cement composition.

The polymeric fluid loss control additives in the foamed cement compositions of the present invention generally comprise a copolymer. The polymeric fluid loss control additives of the present invention have surprisingly been shown to reduce fluid loss from a foamed cement composition without destabilization of the foamed cement composition due, at least in part, to their low dispersive properties. Suitable copolymers may be derived from a number of compounds. In certain embodiments, copolymers useful in the present invention may comprise:
(a) between 5% and about 95% by weight of structural units of Formula I and/or II: 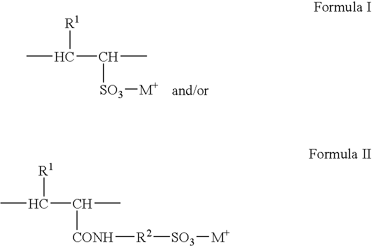
wherein R¹ is H or CH₃, R² is C₂₋₁₀ alkylene, and M⁺ is NH₄⁺, Li⁺, Na⁺, or K⁺, and
(b) between about 5% and about 60% by weight of structural units of Formula III: 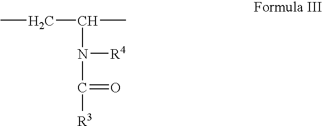
wherein R³ is H, CH₃, or C₂H₅, R⁴ is CH₃ or C₂H₅, or wherein R³ and R⁴ together are a propylene group which with incorporation of the radical 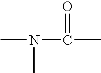
forms a pyrrolidone radical. In certain embodiments, the copolymers further comprise between about 0% and about 60% by weight of structural units of Formula IV: 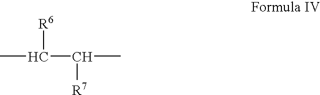
wherein R⁶ is H or CH₃, and R⁷ is carboxamido, carboxyl, cyano, or carboxymethoxy. In certain embodiments, a suitable copolymer may comprise between about 30% and about 80% by weight of structural units of Formula I and/or Formula II, between about 10% and about 30% structural units of Formula III, and between about 10% and about 50% structural units of Formula IV. Suitable copolymers having groups of Formulae I and/or II, III, and optionally IV are more fully described in U.S. Pat. No. 4,587,283, the relevant disclosure of which is incorporated herein by reference.

A wide variety of compounds may be used to derive the structural units having Formulae I and/or II, III, and optionally IV. For example, suitable structural units within Formula I may be derived from vinyl- or allyl-sulfonic acids or alkali metal or ammonium salts thereof. For example, suitable structural units within Formula II may be derived from 2-acrylamido-2-methyl-propane-sulfonic acid and acid salts thereof. For example, suitable structural units within Formula III may be derived from N-vinyl-N-methylacetamide or N-vinylpyrrolidone. For example, suitable structural units within Formula IV may be derived from acrylamides, acrylic acid, acrylonitriles or methyl acrylates, or the corresponding methacrylic compounds. Those skilled in the art will recognize other suitable compounds that may be used to derive structural units having Formulae I and/or II, III, and optionally IV.

Suitable copolymers comprising the above structural units having Formulae I and/or II, III, and optionally IV, include, but are not limited to the following copolymers: (1) a copolymer comprising acrylamide, N-vinyl-N-methylacetamide, and sodium salt of vinyl suflonate; (2) a copolymer comprising partially hydrolyzed acrylamide, N-vinyl-N-methylacetamide, and 2-acrylamido-2-methylpropane sulfonic acid salt; (3) a copolymer comprising 2-acrylamido-2-methylpropane sulfonic acid salt, N-vinyl-N-methylacetamide, and acrylamide; and (4) a copolymer comprising 2-acrylamido-2-methylpropane sulfonic acid salt, acrylamide, N-vinylpyrrolidone, and acrylic acid. In certain embodiments, a suitable copolymer may comprise 2-acrylamido-2-methylpropane sulfonic acid ammonium salt in an amount in the range of from about 58% and about 70% by weight, acrylamide in an amount in the range of from about 15% and about 20% by weight, N-vinylpyrrolidone in an amount in the range of from about 10% and about 20% by weight, and acrylic acid in an amount in the range of from about 1% and about 5% by weight.

In certain embodiments, suitable copolymers of the polymeric fluid loss control additives of the present invention may comprise:
(a) between 5% and about 95% by weight of structural units that are derived from compounds of Formula V: 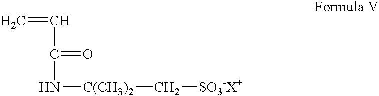
(b) between about 1% and about 95% by weight of structural units that are derived from compounds of Formula VI: 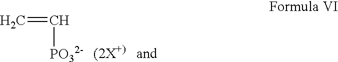
(c) between about 1% and about 95% by weight of structural units that are derived from compounds of Formula VII and/or Formula VIII: 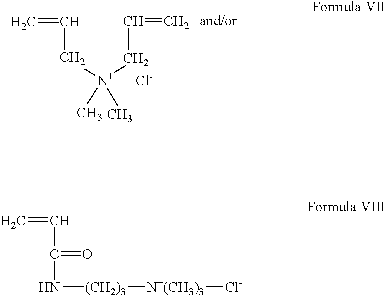
wherein X may be any suitable cation, such as a monovalent or a divalent metal cation (e.g., NH₄⁺, Mg⁺, Na⁺, K⁺, Ca⁺). In one embodiment, the copolymers further comprise between about 2% and about 95%, by weight of structural units that are derived from compounds of Formula IX: 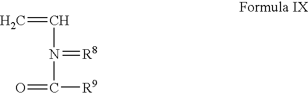
wherein R⁸ and R⁹ independent of one another are a hydrogen or a C₁ to C₄ alkyl, or R⁸ and R⁹ together may form a ring. In the embodiments where R⁸ and R⁹ together form a ring, R⁸ and R⁹ together are —(CH₂)ₙ—, wherein n is 3, 4, or 5. In certain embodiments, R⁸ and R⁹ are H; R⁸ and R⁹ are CH₃; R⁸ is CH₃ and R⁹ is H; or R⁸ and R⁹ together form a ring wherein n is 3 or 4. Suitable copolymers comprising structural units derived from Formula V, VI, VII and/or VIII, and optionally IX, are more fully described in U.S. Pat. No. 6,395,853, the relevant disclosure of which is incorporated herein by reference.

In certain embodiments, a suitable copolymer may comprise between about 40% and about 90% by weight of structural units that are derived from compounds of Formula V. In certain embodiments, a suitable copolymer may comprise between about 45% and about 80% by weight of structural units that are derived from compounds of Formula V. In certain embodiments, a suitable copolymer may comprise between about 1% and about 40% by weight of structural units that are derived from compounds of Formula VI. In certain embodiments, a suitable copolymer may comprise between about 1% and about 10% by weight of structural units that are derived from compounds of Formula VI. In certain embodiments, a suitable copolymer may comprise between about 1% and about 50% by weight of structural units that are derived from compounds of Formula VII. In certain embodiments, a suitable copolymer may comprise between about 1% and about 30% by weight of structural units that are derived from compounds of Formula VII.

A wide variety of compounds having Formulae V, VI, VII, VIII, and IX may be used to derive suitable copolymers. Those skilled in the art will be able to recognize suitable compounds having Formulae V, VI, VII, VIII, and IX that may be used to derive suitable copolymers. For example, in certain embodiments, suitable copolymers may comprise acrylamide, acrylic acid, or mixtures thereof. In certain embodiments, in range of between about 1% and about 80% by weight of the structural units are derived from acrylamide, acrylic acid, or mixtures thereof. In certain embodiments, in the range of from about 10% and about 60% by weight of the structural units are derived from acrylamide, acrylic acid, or mixtures thereof. An example of a suitable copolymer comprising structural units derived from Formula V, VI, VII or VIII, and optionally IX is a copolymer comprising 2-acrylamido-2-methylpropane sulfonic acid sodium salt, acrylic acid, acrylamide, vinyl phosphonic acid, and diallyldimethyl ammonium chloride. In some embodiments a suitable copolymer may comprise 2-acrylamido-2-methylpropane sulfonic acid sodium salt in an amount in the range of from about 60% and about 80% by weight, acrylic acid in an amount in the range of from about 1% and about 5% by weight, acrylamide in an amount in the range of from about 15% and about 30% by weight, vinyl phosphonic acid in an amount in the range of from about 1% and about 2% by weight, and diallyldimethyl ammonium chloride in an amount in the range of from about 1% and about 5%.

Suitable polymeric fluid loss control additives useful in the present invention may comprise any of the above-described copolymers or combinations thereof. The polymeric fluid loss control additive should generally be included in the foamed cement compositions of the present invention in an amount sufficient to provide the desired fluid loss control. In some embodiments, the polymeric fluid loss control additive may be present in an amount in the range of from about 0.25% and about 5% bwoc.

Optionally, other additional additives may be added to the foamed cement compositions of the present invention as deemed appropriate by one skilled in the art, with the benefit of this disclosure. Examples of such additives include, but are not limited to, lost circulation materials, crystalline silica compounds, dispersants, accelerators, retarders, salts, fibers, formation conditioning agents, amorphous silica, bentonite, microspheres, weighting materials (e.g., oxides of iron, oxides of manganese, etc.), and the like.

The foamed cement compositions of the present invention may be prepared in accordance with any suitable technique. For example, the hydraulic cement and water may be combined and mixed for a sufficient period of time to form a pumpable cement composition. Liquid additives, if any, can be mixed with the water prior to combination with the hydraulic cement. Dry solid additives, if any, can be dry blended with the cement prior to combination with the water. In certain embodiments, the cement composition then may be pumped to the well bore, and the foaming and stabilizing surfactant followed by the gas may be injected into the cement composition as the cement composition is being pumped. Those of ordinary skill in the art, with the benefit of this disclosure, will recognize other suitable techniques for preparing the foamed cement compositions of the present invention.

An example of a method of cementing of the present invention comprises: providing a foamed cement composition that comprises a hydraulic cement, water, a gas, a foaming and stabilizing surfactant, and a fluid loss control additive of the present invention; placing the foamed cement composition in a location to be cemented; and allowing the foamed cement composition to set. The location to be cemented may be any suitable location, including a location above ground or a portion of a subterranean formation, such as between the walls of a well bore and the exterior surface of a pipe string disposed therein.

Another example of a method of cementing of the present invention comprises: providing a cement composition that comprises a hydraulic cement, water, a foaming and stabilizing surfactant, and a fluid loss control additive of the present invention; combining the cement composition with a gas to form a foamed cement composition; placing the foamed cement composition in a portion of a subterranean formation; and allowing the foamed cement composition to set therein.

To facilitate a better understanding of the present invention, the following examples of certain aspects of some embodiments are given. In no way should the following examples be read to limit, or define, the scope of the invention.

### EXAMPLE 1

A non-foamed cement composition (Sample No. 1) was prepared having a density of 16.1 lbs/gal comprising water, Joppa Class H cement, silica flour present in an amount of 35% bwoc, amorphous silica present in an amount of 5% bwoc, a non-dispersing set retarder present in an amount of 0.6% bwoc, a foaming and stabilizing surfactant present in an amount of 2% by volume of water (“bvow”), and a fluid loss control additive of this invention present in an amount of 0.75% bwoc. The non-dispersing retarder comprised a mixture of a lignosulfonate, a sugar acid and a sulfonated lignin and is described in U.S. Pat. No. 6,227,294, the relevant disclosure of which is incorporate herein by reference. The foaming and stabilizing surfactant comprised a mixture of an ammonium salt of an alkyl ether sulfate surfactant, a cocoamidopropyl betaine surfactant, a cocoamidopropyl dimethylamine oxide surfactant, sodium chloride and water. The fluid loss control additive of the present invention used in this example comprised a copolymer of 65% by weight of an ammonium salt of 2-acrylamido-2-methylpropane sulfonic acid salt, 17% by weight of acrylamide, 12% by weight of N-vinylpyrrolidone, and 3% by weight of acrylic acid.

A second non-foamed cement composition (Sample No. 2) was prepared including the amounts of the components described above except that the composition included 10% bwoc of amorphous silica instead of 5% bwoc and 1% bwoc of the non-dispersing set retarder described above instead of 0.6% bwoc and a foaming and stabilizing surfactant comprising a mixture of an ammonium salt of an alkyl ether sulfate surfactant, a cocoamidopropyl hydroxysultaine surfactant, a cocoamidopropyl dimethylamine oxide surfactant, sodium chloride and water present in an amount of 2% bvow instead of the foaming and stabilizing surfactant described above.

Portions of Sample No. 1 and Sample No. 2 were tested for fluid loss in accordance with the API Fluid Loss Test Procedure at 200° F. and 1000 psi.

Portions of Sample No. 1 and Sample No. 2 were tested for stirring fluid loss at temperatures of 250° F. and pressures of 1000 psi.

The results of these tests are set forth in Table I below.

TABLE I
Non-Foamed Fluid Loss

| Sample | Temperature, ° F. | Pressure, psi | API cc/30 min |
|---|---|---|---|
| No. 1 | 200 | 1000 | 40 |
| No. 2 | 200 | 1000 | 46 |
| No. 1 | 250 | 1000 | 56 |
| No. 2 | 250 | 1000 | 32 |

From Table I, it can be seen that this example of a fluid loss control additive of the present invent prevented significant fluid loss from the sample cement compositions.

### EXAMPLE 2

Additional portions of the non-foamed cement compositions (Sample No. 1 & 2) described in Example 1 above were foamed down to a density of 11.96 lbs/gal and tested for fluid loss properties using a MACS Analyzer. The MACS Analyzer is described in U.S. Pat. No. 6,227,294, the relevant disclosure of which is incorporated herein by reference. Instead of using two transfer cells designed for testing the foam stability, only one cell was used for that purpose. The second cell was replaced with a static fluid loss cell that had been modified to connect to the transfer line from the MACS Analyzer and with a vent for filling the same as the cells used for stability testing. After the transfer cell was filled for the stability test, the remaining foamed cement was transferred to the fluid loss cell which was at the same temperature and pressure. After the fluid loss cell was filled, a standard static fluid loss test was preformed on the foamed cement composition. The filtrate from the fluid loss cell was foamed and a drop of defoamer was added to the filtrate to break the foam prior to reporting the fluid loss data. The results of these tests are shown in Table II below.

TABLE II
Foamed Fluid Loss

| | Density, | Temperature | Pressure, | API cc/ |
|---|---|---|---|---|
| Sample | lb/gal | ° F. | psi | 30 min |
| No. 1 | 11.96 | 200 | 1000 | 30 |
| No. 2 | 11.53 | 200 | 1000 | 40 |

From Table II, it can again be seen that this example of a fluid loss control additive of the present invention prevented significant fluid loss from a foamed cement composition.

### EXAMPLE 3

A base cement composition was prepared having a density of 16.1 lbs/gal comprising water, Joppa Class H cement, silica flour present in an amount of 35% bwoc, amorphous silica in an amount of 10% bwoc, the non-dispersing set retarder described above in Example 1 present in an amount of 1% bwoc and a foaming and stabilizing surfactant in an amount of 2% bvow). The foaming and stabilizing surfactant comprised a mixture of an ammonium salt of an alkyl ether sulfate surfactant, a cocoamidopropyl betaine surfactant, a cocoamidopropyl dimethylamine oxide surfactant, sodium chloride and water.

Sample No. 3 comprised the base cement composition. A portion of Sample No. 3 was foamed down to a density of 10.75 lbs/gal and cured at 140° F. for 72 hours. The density of the cured portion was determined at the top, middle and bottom.

Sample No. 4 comprised the base cement composition and 1% bwoc of a fluid loss control additive of the present invention. The fluid loss control additive of the present invention used is described above in Example 1. A portion of Sample No. 4 was foamed down to a density of 10.75 lbs/gal and cured at 140° F. for 72 hours. The density of the cured portion was determined at the top, middle and bottom.

Sample No. 5 was the same as the base cement composition except that the foaming and stabilizing surfactant used comprised an ammonium salt of an alkyl ether sulfate surfactant, a cocoamidopropyl hydroxysultaine surfactant, a cocoamidopropyl dimethylamine oxide surfactant, sodium chloride and water. A portion of Sample No. 5 was foamed down to 11.77 lbs/gal. and cured at 140° F. for 72 hours. The density of the cured portion was determined at the top, middle and bottom.

Sample No. 6 was the same as Sample No. 5 except that the sample further comprised 0.75% bwoc of a fluid loss control additive of the present invention. The fluid loss control additive of the present invention used is described above in Example 1. A portion of Sample No. 6 was foamed down to 11.77 lbs/gal. and cured at 140° F. for 72 hours. The density of the cured portion was determined at the top, middle and bottom.

The results of the tests are given in Table III.

TABLE III
Foamed Density After Set

| | | Foaming | | | | | | |
|---|---|---|---|---|---|---|---|---|
| | Fluid | and | | | | | | |
| | Loss | stabilizing | Calculated | 15 sec | Curing | Density After Set, | | |
| | Additive, | surfactant, | Density, | Density | Temp., | lb/gal | | |
| Sample | % | % bvow | lb/gal | lb/gal | ° F. | Top | Middle | Bottom |
| No. 3 | — | 2 | 11.5 | 11.75 | 140 | 10.59 | 10.65 | 10.67 |
| No. 4 | 1% | 2 | 11.5 | 11.77 | 140 | 11.66 | 11.76 | 11.78 |
| No. 5 | — | 2 | 11.5 | — | 140 | 10.73 | 10.80 | 10.84 |
| No. 6 | 1% | 2 | 11.5 | — | 140 | 11.99 | 11.96 | 12.05 |

From Table III, it can be seen that this example of a fluid loss control additives of the present invention did not destabilize foamed cement compositions.

### EXAMPLE 4

Using the MACS Analyzer, portions of Sample No. 1 from Example 1, with and without a fluid loss control additive of the present invention, were foamed down to 10.3 lbs/gal at 200° F. and 1000 psi and then cured at 250° F. for 72 hours. As shown in Table IV below, the cured cement including an example of a fluid loss control additive of the present invention had a variation in slurry density with the average density being 12.26 lbs/gal.

TABLE IV

| Fluid | | | | | | | |
|---|---|---|---|---|---|---|---|
| Loss | Calculated | Transfer | Curing | Actual | Density After Set, | | |
| Additive, | Density, | Temperature | Temperature | Density, | lb/gal | | |
| % | lb/gal | ° F. | ° F. | lb/gal | Top | Middle | Bottom |
| — | 11.5 | 200 | 250 | 10.39 | 10.49 | 10.40 | 10.24 |
| 0.75% | 11.5 | 200 | 250 | 11.9 | 11.71 | 12.01 | 12.06 |

Thus, as shown in Table IV, this example of a fluid loss control additive of this invention did not affect the stability of the foamed cement composition when generated under temperature and pressure and when it includes a foaming and stabilizing surfactant comprising the ammonium salt of alkyl ether sulfate, cocoamidopropyl betaine and cocoamidopropyl dimethylamine oxide.

### EXAMPLE 5

Sample No. 7 was prepared for this series of tests. Sample No. 7 was the same as Sample No. 1 except that the foaming and stabilizing surfactant used comprised a mixture of an ammonium salt of alkyl ether sulfate, cocoamidopropyl hydroxysultaine and cocoamidopropyl dimethylamine oxide.

Foam transfer data were generated using a Mini-Max Analyzer. The Mini-Max Analyzer was modified to prepare the foamed cement composition under pressure. The modifications consisted of a special tapered slurry cup with a special seal system, high speed rotation of the paddle inside the slurry cup and a nitrogen pressure source. The unfoamed cement composition was placed into the special slurry cup and sealed. The slurry weight is the amount that will provide the desired slurry density for the volume of the cup. The slurry cup was placed into the modified Mini-Max Analyzer and stirred at 1000 rpm for 10 minutes with 1000 psi nitrogen pressure applied. The speed was then reduced to 150 rpm (standard API stirring speed) and the temperature increased to a bottom hole circulating temperature of 200° F. Upon reaching BHCT (time for the cement composition to reach the bottom hole conditions), the stirring was stopped and the temperature was increased to 250° F., the bottom hole static temperature at the end of 4 hours from the start of the test. After curing for 72 hours, the Mini-Max Analyzer was cooled to room temperature to allow inspection of the set foamed slurry. The nitrogen pressure was released very slowly, normally over a 2 to 4 hour period of time. After the Mini-Max Analyzer was cooled and pressure was released, the slurry cup was removed, opened, and the slurry was pressed from the slurry cup. The set foamed cement composition was then used to determine the slurry density. This was done by taking sections from top, middle and bottom of the set composition and measuring the densities. Density measurements were carried out by using Archimedes Principal. Densities that were close in weight from top to bottom indicate stable foam while considerable variation in densities indicate unstable foam. The results of this test are shown in Table V below.

TABLE V
Foamed Density After Set

| | Calculated | Curing | | | |
|---|---|---|---|---|---|
| | Density, | Temperature | Density After Set, lb/gal | | |
| Sample | lb/gal | ° F. | Top | Middle | Bottom |
| No. 7 | 11.5 | 250 | 10.13 | 10.01 | 10.26 |

From Table V, it can be seen that the foamed cement composition produced densities ranging from 10.13 to 10.26 lbs/gal thereby indicating that this example of a fluid loss control additive of this invention should not affect the stability of a foamed cement composition generated under high temperature and pressure.

### EXAMPLE 6

For this series of tests three sample cement compositions were prepared. After preparation, a portion of the sample cement composition was foamed down to a desired density and allowed to cure at 140° F. for 24 hours. The compressive strength of the cured portion of each sample was determined, and the density of the cured portion of each sample was determined at the top, middle and bottom.

Sample No. 8 was prepared having a density of 16.35 lb/gal and comprising water and Norcem Class G cement. Sample No. 8 was foamed down to 10.97 lb/gal and cured at 140° F. for 24 hours.

Sample No. 9 was prepared having a density of 16.21 lb/gal and comprising water, Norcem Class G cement, and a fluid loss control additive of the present invention in an amount of 1.44% bwoc. The fluid loss control additive of the present invention used in this sample comprised a copolymer of 2-acrylamido-2-methylpropane sulfonic acid sodium salt, acrylic acid, acrylamide, and vinyl phosphonic acid. Sample No. 9 was foamed down to 11.48 lb/gal and cured at 140° F. for 24 hours.

Sample No. 10 having a density of 15.28 lb/gal and comprising water, Norcem Class G cement, amorphous silica in an amount of 10.6% bwoc, and a fluid loss control additive of the present invention in an amount of 1.44% bwoc. The fluid loss control additive of the present invention comprised a copolymer of 2-acrylamido-2-methylpropane sulfonic acid sodium salt, acrylic acid, acrylamide, and vinyl phosphonic acid. Sample No. 10 was foamed down to 10.88 lb/gal and cured at 140° F. for 24 hours.

The results of these tests are shown in Table VI below.

TABLE VI
Foamed Density After Set

| | Fluid | | | | | | |
|---|---|---|---|---|---|---|---|
| | Loss | Amorphous | | Compressive | | | |
| | Additive | Silica | Density | Strength | Density After Set, lb/gal | | |
| Sample | (bwoc) | (bwoc) | (lb/gal) | (psi) | Top | Middle | Bottom |
| No. 8 | — | — | 10.97 | 864 | 10.43 | 10.61 | 10.69 |
| No. 9 | 1.44 | — | 11.48 | 1397 | 11.33 | 11.55 | 11.79 |
| No. 10 | 1.44 | 10.6 | 10.88 | 1431 | 10.77 | 10.79 | 10.84 |

From Table VI, it can be seen that this example of a fluid loss control additive of the present invention did not destabilize foamed cement slurries.

### EXAMPLE 7

A non-foamed cement composition (Sample No. 11) was prepared having a density of 16.1 lbs/gal and comprising water, Joppa Class H cement, silica flour in an amount of 35% bwoc, amorphous silica in an amount of 5% bwoc, a non-dispersing retarder in an amount of 0.6% bwoc, a foaming and stabilizing surfactant in an amount of 2% bvow, and a fluid loss control additive of the present invention in an amount of 1% bwoc. The non-dispersing retarder comprised a mixture of a lignosulfonate, a sugar acid and a sulfonated lignin is described in U.S. Pat. No. 6,227,294, the relevant disclosure of which is incorporated herein by reference. The foaming and stabilizing surfactant comprised a mixture of an ammonium salt of an alkyl ether sulfate surfactant, a cocoamidopropyl betaine surfactant, a cocoamidopropyl dimethylamine oxide surfactant, sodium chloride, and water. The fluid loss control additive of the present invention used in this example comprised a copolymer of copolymer of 2-acrylamido-2-methylpropane sulfonic acid sodium salt, acrylic acid, acrylamide, and vinyl phosphonic acid.

Portions of Sample No. 11 were tested for stirring fluid loss at temperatures of 250° F. and pressures of 1000 psi. The results of these tests are set forth in Table VII below.

TABLE VII
Stirring Fluid Loss

| Sample | Temperature, ° F. | Pressure, psi | API cc/30 min |
|---|---|---|---|
| No. 11 | 250 | 1,000 | 102 |

From Table VII, it can be seen that this example of a fluid loss control additive of the present invention prevented significant fluid loss from the non-foamed cement composition.

### EXAMPLE 8

A non-foamed cement composition (Sample No. 12) was prepared having a density of 16.2 lbs/gal and comprising Joppa Class H cement, silica flour in an amount of 35% bwoc, amorphous silica in an amount of 5% bwoc, a non-dispersing retarder in an amount of 0.6% bwoc, a foaming and stabilizing surfactant in an amount of 2% bvow, and a fluid loss control additive of the present invention in an amount of 0.75% bwoc. The non-dispersing retarder comprised a mixture of a lignosulfonate, a sugar acid and a sulfonated lignin and is described in U.S. Pat. No. 6,227,294, the relevant disclosure of which is incorporated herein by reference. The foaming and stabilizing surfactant comprised a mixture of an ammonium salt of an alkyl ether sulfate surfactant, a cocoamidopropyl betaine surfactant, a cocoamidopropyl dimethylamine oxide surfactant, sodium chloride and water. The fluid loss control additive of the present invention used in this example comprised a copolymer of copolymer of 2-acrylamido-2-methylpropane sulfonic acid sodium salt, acrylic acid, acrylamide, and vinyl phosphonic acid.

A portion of Sample No. 12 was foamed down to a density of 11.5 lbs/gal and tested for fluid loss properties using the MACS Analyzer. Instead of using two transfer cells designed for testing the foam stability, only one cell was used for that purpose. The second cell was replaced with a static fluid loss cell that had been modified to connect to the transfer line from the MACS Analyzer and with a vent for filling the same as the cells used for stability testing. After the transfer cell was filled for the stability test, the remaining foamed cement was transferred to the fluid loss cell which was at the same temperature and pressure. After the fluid loss cell was filled, a standard static fluid loss test was preformed on the foamed slurry. The filtrate from the fluid loss cell was foamed and a drop of defoamer was added to the filtrate to break the foam prior to reporting the fluid loss data. The results of these tests are shown in Table VIII below.

TABLE VIII
Foamed Fluid Loss

| | Density, | Temperature | Pressure, | API cc/ |
|---|---|---|---|---|
| Sample | lb/gal | ° F. | psi | 30 min |
| No. 12 | 11.5 | 200 | 1,000 | 30 |

From Table VII, it can again be seen that this example of a fluid loss control additive of the present invention prevented significant fluid loss from foamed a foamed cement composition.

### EXAMPLE 9

Using the MACS Analyzer, a portion of Sample No. 12 was foamed down to 11.5 lbs/gal at 200° F. and 1000 psi and then cured at 250° F. for 72 hours. The density of the cured portion was determined for the top, middle, and bottom. The results of this test are shown in Table IX below.

TABLE IX

| Fluid | | | | | | | |
|---|---|---|---|---|---|---|---|
| Loss | Calculated | Transfer | Curing | Actual | Density After Set, | | |
| Additive, | Density, | Temperature | Temperature | Density, | lb/gal | | |
| % bwoc | lb/gal | ° F. | ° F. | lb/gal | Top | Middle | Bottom |
| 0.75 | 11.5 | 200 | 250 | 12.39 | 11.8 | 12.43 | 12.73 |

Thus, as shown in Table VIII, this example of a fluid loss control additive of this invention did not affect the stability of the foamed cement composition when generated under temperature and pressure and when it included a foaming and stabilizing surfactant comprising the ammonium salt of alkyl ether sulfate, cocoamidopropyl betaine and cocoamidopropyl dimethylamine oxide.

Therefore, the present invention is well adapted to attain the ends and advantages mentioned as well as those that are inherent therein. While numerous changes may be made by those skilled in the art, such changes are encompassed within the spirit of this invention as defined by the appended claims. The terms in the claims have their plain, ordinary meaning unless otherwise explicitly and clearly defmed by the patentee.

1. A foamed cement composition, comprising:
a hydraulic cement;
water;
a gas;
a foaming and stabilizing surfactant; and
a polymeric foam fluid loss control additive comprising a copolymer that comprises:
(a) between 5% and about 95% by weight of structural units of Formula I and/or II: 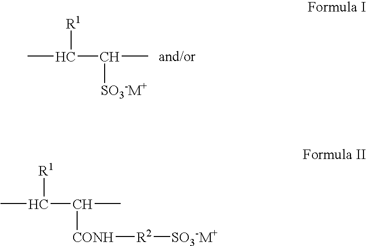
wherein R¹ is H or CH₃, R² is C₂₋₁₀ alkylene, and M⁺ is NH₄⁺, Li⁺, Na⁺, or K⁺, and
(b) between about 5% and about 60% by weight of structural units of Formula III: 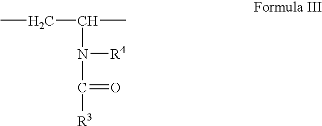
wherein R³ is H, CH₃, or C₂H₅, R⁴ is CH₃ or C₂H₅, or wherein R³ and R⁴ together are a propylene group which with incorporation of the radical 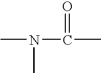
forms a pyrrolidone radical.

2. The foamed cement composition of claim 1 wherein the water comprises at least one of the following: freshwater; saltwater, a brine, or seawater.

3. The foamed cement composition of claim 1 wherein the foaming and stabilizing surfactant comprises at least one of the following: a mixture of an ammonium salt of an alkyl ether sulfate, a cocoamidopropyl betaine surfactant, a cocoamidopropyl dimethylamine oxide surfactant, sodium chloride, and water; a mixture of an ammonium salt of an alkyl ether sulfate surfactant, a cocoamidopropyl hydroxysultaine surfactant, a cocoamidopropyl dimethylamine oxide surfactant, sodium chloride, and water; a hydrolyzed keratin; a mixture of an ethoxylated alcohol ether sulfate surfactant, an alkyl or alkene amidopropyl betaine surfactant, and an alkyl or alkene dimethylamine oxide surfactant; or an aqueous solution of an alpha-olefinic sulfonate surfactant and a betaine surfactant.

4. The foamed cement composition of claim 1 wherein the polymeric fluid loss control additive comprises at least one of the following:
a copolymer comprising acrylamide, N-vinyl-N-methylacetamide, and sodium salt of vinyl sulfonate;
a copolymer comprising partially hydrolyzed acrylamide, N-vinyl-N-methylacetamide, and 2-acrylamido-2-methylpropane sulfonic acid salt;
a copolymer comprising 2-acrylamido-2-methylpropane sulfonic acid salt, N-vinyl-N-methylacetamide, and acrylamide; or
a copolymer comprising 2-acrylamido-2-methylpropane sulfonic acid, acrylamide, N-vinylpyrrolidone, and acrylic acid.

5. The foamed cement composition of claim 1 wherein the polymeric fluid loss control additive is present in the foamed cement composition in an amount in the range of from about 0.25% and about 5% bwoc.

6. The foamed cement composition of claim 1 wherein the polymeric foam fluid loss control additive comprises a second copolymer that comprises:
(a) between 5% and about 95% by weight of structural units that are derived from compounds of Formula V: 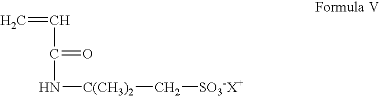
(b) between about 1% and about 95% by weight of structural units that are derived from compounds of Formula VI: 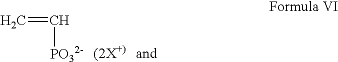
(c) between about 1% and about 95% by weight of structural units that are derived from compounds of Formula VII and/or Formula VIII: 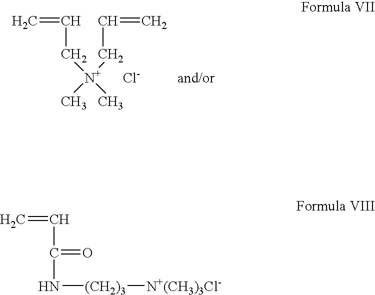
wherein X⁺ is a cation.

7. The foamed cement composition of claim 1 wherein the copolymer further comprises between about 0% and about 60% by weight of structural units of Formula IV: 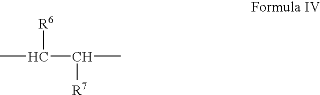
wherein R⁶ is H or CH₃, and R⁷ is carboxamido, carboxyl, cyano, or carboxymethoxy.

8. The foamed cement composition of claim 5 wherein the copolymer comprises:
between about 30% and about 80% by weight of structural units of Formula I and/or Formula II;
between about 10% and about 30% structural units of Formula III; and
between about 10% and about 50% structural units of Formula IV.

9. The foamed cement composition of claim 5 wherein the copolymer comprises:
2-acrylamido-2-methylpropane sulfonic acid ammonium salt in an amount in the range of from about 58% and about 70% by weight;
acrylamide in an amount in the range of from about 15% and about 20% by weight;
N-vinylpyrrolidone in an amount in the range of from about 10% and about 20% by weight; and
acrylic acid in an amount in the range of from about 1% and about 5% by weight.

10. A foamed cement composition, comprising:
a hydraulic cement;
water;
a gas;
a foaming and stabilizing surfactant; and
a polymeric foam fluid loss control additive comprising a copolymer that comprises:
(a) between 5% and about 95% by weight of structural units that are derived from compounds of Formula V: 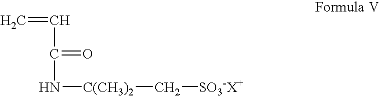
(b) between about 1% and about 95% by weight of structural units that are derived from compounds of Formula VI: 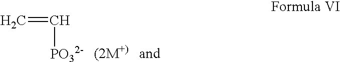
(c) between about 1% and about 95% by weight of structural units that are derived from compounds of Formula VII or Formula VIII: 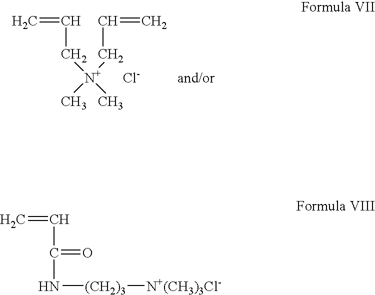
wherein X⁺ is a cation.

11. The foamed cement composition of claim 10 wherein the water comprises at least one of the following: freshwater; saltwater, a brine, or seawater.

12. The foamed cement composition of claim 10 wherein the foaming and stabilizing surfactant comprises at least one of the following: a mixture of an ammonium salt of an alkyl ether sulfate, a cocoamidopropyl betaine surfactant, a cocoamidopropyl dimethylamine oxide surfactant, sodium chloride, and water; a mixture of an ammonium salt of an alkyl ether sulfate surfactant, a cocoamidopropyl hydroxysultaine surfactant, a cocoamidopropyl dimethylamine oxide surfactant, sodium chloride, and water; a hydrolyzed keratin; a mixture of an ethoxylated alcohol ether sulfate surfactant, an alkyl or alkene amidopropyl betaine surfactant, and an alkyl or alkene dimethylamine oxide surfactant; or an aqueous solution of an alpha-olefinic sulfonate surfactant and a betaine surfactant.

13. The foamed cement composition of claim 10 wherein the polymeric fluid loss control additive is present in the foamed cement composition in an amount in the range of from about 0.25% and about 5% bwoc.

14. The foamed cement composition of claim 10 wherein the polymeric foam fluid loss control additive further comprises a second copolymer that comprises:
(a) between 5% and about 95% by weight of structural units of Formula I and/or II: 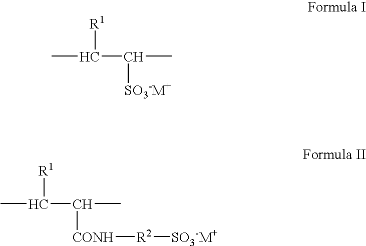
wherein R¹ is H or CH₃, R² is C₂₋₁₀ alkylene, and M⁺ is NH₄⁺, Li⁺, Na⁺, or K⁺, and
(b) between about 5% and about 60% by weight of structural units of Formula III: 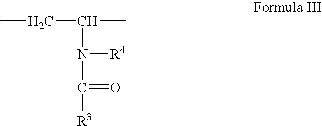
wherein R³ is H, CH₃, or C₂H₅, R⁴ is CH₃ or C₂H₅, or wherein R³ and R⁴ together are a propylene group which with incorporation of the radical 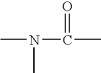
forms a pyrrolidone radical.

15. The foamed cement composition of claim 10 wherein the copolymer further comprises between about 2% and about 95%, by weight of structural units that are derived from compounds of Formula IX: 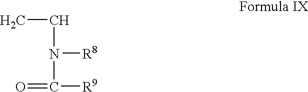
wherein R⁸ and R⁹ independent of one another are a hydrogen or a C₁ to C₄ alkyl, or R⁸ and R⁹ together form a ring having the formula —(CH₂)ₙ—, wherein n is 3, 4, or 5.

16. The foamed cement composition of claim 15 wherein the copolymer comprises 2-acrylamido-2-methylpropane sulfonic acid sodium salt, acrylic acid, acrylamide, vinyl phosphonic acid, and diallyldimethyl ammonium chloride.

17. The foamed cement composition of claim 15 wherein R⁸ and R⁹ are H; R⁸ and R⁹ are CH₃; R⁸ is CH₃ and R⁹ is H; or R⁸ and R⁹ together form the ring wherein n is 3 or 4.

18. The foamed cement composition of claim 10 wherein the copolymer comprises:
between about 40% and about 90% by weight of structural units that are derived from compounds of Formula V;
between about 1% and about 40% by weight of structural units that are derived from compounds of Formula VI; and
between about 1% and about 50% by weight of structural units that are derived from compounds of Formula VII.

19. The foamed cement composition of claim 10 wherein the copolymer comprises:
between about 45% and about 80% by weight of structural units that are derived from compounds of Formula V;
between about 1% and about 10% by weight of structural units that are derived from compounds of Formula VI; and
between about 1% and about 30% by weight of structural units that are derived from compounds of Formula VII.

20. The foamed cement composition of claim 10 wherein the copolymer comprises at least one of the following: acrylamide or acrylic acid.

21. The foamed cement composition of claim 10 wherein the copolymer comprises in the range of from about 1% and about 80% by weight of structural units derived from acrylamide, acrylic acid, or mixtures thereof.
